(19) United States
(12) Patent Application Publication
(10) Pub. No.: US 2026/0210511 A1
(43) Pub. Date: Jul. 23, 2026

(54) LIGHTING MODULE, LAMP DEVICE AND VEHICLE

(71) Applicant: VALEO VISION, Bobigny (FR)

(72) Inventors: Si CHEN, Bobigny (FR); Ke YU, Bobigny (FR); Lei FAN, Bobigny (FR)

(73) Assignee: VALEO VISION, Bobigny (FR)

(21) Appl. No.: 19/142,860

(22) PCT Filed: Dec. 22, 2023
(86) PCT No.: PCT/EP2023/087775

§ 371 Date: Jun. 24, 2025

(30) Foreign Application Priority Data
Dec. 27, 2022 (CN) 202211691317.5

(51) Int. Cl. F21S 41/30; F21S 45/47; F21W 102/135

(52) U.S. Cl. CPC F21S 41/30; F21S 45/47; F21W 2102/135

(57) ABSTRACT

A lighting module, a lamp device and a vehicle are provided. The lighting module includes a light source and a light shaping component configured to shape the light from the light source into a beam with a desired lighting function for emission and includes a light collection portion and a cut-off line forming portion that are integrated, the light collection portion being configured to collect the light from the light source and guide the light towards the cut-off line forming portion, and the cut-off line forming portion being configured to receive the light from the light collection portion and shape the light into an outgoing beam with a cut-off line.

### TECHNICAL FIELD

Embodiments of the present disclosure generally relate to the field of lighting and/or signal indication, and more specifically, to a lighting module that allows a reduction of manufacturing costs, as well as a lamp device and a vehicle equipped with such a lighting module.

### BACKGROUND OF THE INVENTION

Various lamp devices are known in various fields for providing light for lighting or signaling. For example, vehicle lamps are used in vehicles to provide lighting or signaling functions, in order to ensure safe driving or provide an ornamental function.

In traffic rules and industry standards, definite requirements are established for the intensity distribution of beams emitted by various vehicle lamps. As an example, it is generally required that a low beam emitted by a headlight of a vehicle have a light and dark cut-off line to meet regulatory and driving safety requirements. In the prior art, a cut-off line forming structure is usually formed as a single independent component and assembled into a vehicle lamp, wherein the material and manufacturing costs of independent components are high, high assembly accuracy is required, and additional assembly space is needed in the vehicle lamp, which results in a large vehicle lamp volume.

### SUMMARY OF THE INVENTION

One purpose of the present disclosure is to solve or overcome at least one of the above and other problems and shortcomings in the prior art.

According to an aspect of the present disclosure, a lighting module is provided, comprising a light source; and a light shaping component configured to shape light from the light source into a beam with a desired lighting function for emission, comprising a light collection portion and a cut-off line forming portion that are integrated, the light collection portion being configured to collect light from the light source and guide the light towards the cut-off line forming portion, and the cut-off line forming portion being configured to receive light from the light collection portion and shape the light into an outgoing beam with a cut-off line.

In some embodiments, at least one of the light collection portion and the cut-off line forming portion comprises a reflector.

In some embodiments, the light collection portion is configured to reflect light from the light source towards the cut-off line forming portion, and the cut-off line forming portion is configured to reflect outwards light reflected from the light collection portion.

In some embodiments, the light collection portion is a reflector with a focal point at or near the light source.

In some embodiments, the cut-off line forming portion comprises a main body spaced apart from the light collection portion and two side connection portions located on two opposite sides of the main body, wherein the side connection portion extends from the main body to the light collection portion, so that the light collection portion and the cut-off line forming portion are formed into one, and an opening that allows light to be emitted is defined between the main body and the light collection portion.

In some embodiments, at least one of the main body of the cut-off line forming portion and the light collection portion has one or more elliptical, parabolic or semi-elliptical reflective surfaces.

In some embodiments, the cut-off line forming portion has a reflective surface with a cut-off line forming structure.

In some embodiments, the light shaping component comprises at least one of a first light shaping component and a second light shaping component, the first light shaping component being configured to provide a first beam with a first lighting function and a first cut-off line, and the second light shaping component being configured to provide a second beam with a second lighting function and a second cut-off line.

In some embodiments, the first lighting function is a low beam function, and the second lighting function is a high beam function. The lighting module comprises the first light shaping component and the second light shaping component arranged adjacent to each other, the first light shaping component and the second light shaping component being each formed as a single component, and the light source comprises one or more first light sources for emitting light to the first light shaping component and one or more second light sources for emitting light to the second light shaping component

In some embodiments, the cut-off line forming portion of the second light shaping component is partially embedded in the cut-off line forming portion of the first light shaping component, so that the cut-off line forming portion of the second light shaping component is at least partially exposed from a gap defined between the light collection portion and the cut-off line forming portion of the second light shaping component.

In some embodiments, the lighting module further comprises a single circuit board, wherein the first light source and the second light source are mounted at intervals on the circuit board.

In some embodiments, the lighting module further comprises a single heat sink, wherein the circuit board, first light shaping component, and second light shaping component are mounted on the heat sink, so that the second light shaping component and the first light shaping component are located on the same side of the circuit board away from the heat sink.

In some embodiments, the circuit board has a U-shaped contour defining an opening, and the first and second light sources are respectively mounted on two sides of the opening having a U-shaped contour.

In some embodiments, the heat sink comprises a heat dissipation plate and a plurality of heat dissipation fins extending from the heat dissipation plate, wherein a groove is formed on the surface of the circuit board facing the heat dissipation plate, and the cut-off line forming portion of the second light shaping component is at least partially positioned inside the groove.

In some embodiments, the lighting module further comprises a lens, wherein the lens is configured to project a beam from a light shaping component outwards to become a lighting beam.

In some embodiments, the light projection component comprises a lens and a lens bracket, wherein the lens is mounted on the lens bracket and the lens bracket is mounted on the heat sink to cover the light shaping component.

In some embodiments, the cut-off line forming portion is formed with a cut-off line forming structure located in or near the focal plane of the lens at the edge.

According to another aspect of the present disclosure, an embodiment further provides a lamp device comprising a lighting module as described in any one of the embodiments disclosed herein.

In some embodiments, the lamp device comprises a lamp for a vehicle.

According to yet another aspect of the present disclosure, an embodiment further provides a vehicle comprising a lighting module or lamp device as described in any one of the embodiments disclosed herein.

A detailed description of the present disclosure is provided below by referring to the attached drawings to make other objectives and advantages of the present disclosure apparent and help achieve a comprehensive understanding of the present disclosure.

### BRIEF DESCRIPTION OF THE DRAWINGS

These and/or other aspects, features and advantages of the present disclosure will become apparent and readily understood from the following description of some illustrative embodiments in conjunction with the accompanying drawings. In the drawings:

FIG. 1 is a lateral perspective view schematically showing the structure of a lighting module according to an exemplary embodiment of the present disclosure;

FIG. 2 is a perspective view schematically showing the structure of a lighting module according to an exemplary embodiment of the present disclosure, with the lens and lens bracket removed;

FIG. 3 is a perspective view schematically showing the structure of a lighting module according to another exemplary embodiment of the present disclosure;

FIG. 4 is a perspective view schematically showing the structure of a lighting module according to yet another exemplary embodiment of the present disclosure;

FIG. 5 is a schematic exploded view showing the structure of a lighting module according to an exemplary embodiment of the present disclosure;

FIG. 6 is a front view schematically showing the structure of a lighting module according to an exemplary embodiment of the present disclosure;

FIG. 7 is a cross-sectional view schematically showing the structure of a lighting module according to an exemplary embodiment of the present disclosure, taken along line A-A in FIG. 6;

FIG. 8 is a front view schematically showing the structure of a lighting module according to another exemplary embodiment of the present disclosure;

FIG. 9 is a cross-sectional view schematically showing the structure of a lighting module according to another exemplary embodiment of the present disclosure, taken along line B-B in FIG. 8;

FIG. 10 is a rear view schematically showing the structure of an integrated light shaping component of a lighting module according to an exemplary embodiment of the present disclosure;

FIG. 11 is a front view schematically showing the structure of a lighting module according to yet another exemplary embodiment of the present disclosure;

FIG. 12 is a cross-sectional view schematically showing the structure of a lighting module according to still another exemplary embodiment of the present disclosure, taken along line C-C in FIG. 11;

FIG. 13 is a schematic diagram of the optical path of a lighting module according to an exemplary embodiment of the present disclosure; and

FIG. 14 is a schematic diagram of the optical path of a lighting module according to another exemplary embodiment of the present disclosure.

### DETAILED DESCRIPTION OF THE INVENTION

Embodiments of the present disclosure will be described in detail below in conjunction with the attached drawings. In this description, the same or similar components are indicated by the same or similar reference numerals. The following explanation of embodiments of the present disclosure with reference to the drawings is intended to explain the overall disclosed concept of the present disclosure, and should not be interpreted as a limitation of the present disclosure.

In addition, in the following detailed description, for ease of explanation, many specific details are given to provide a comprehensive understanding of the embodiments of the present disclosure. However, it is obvious that one or more embodiments may also be implemented without these specific details. In other cases, well-known structures and devices are shown in the form of illustrations to simplify the drawings.

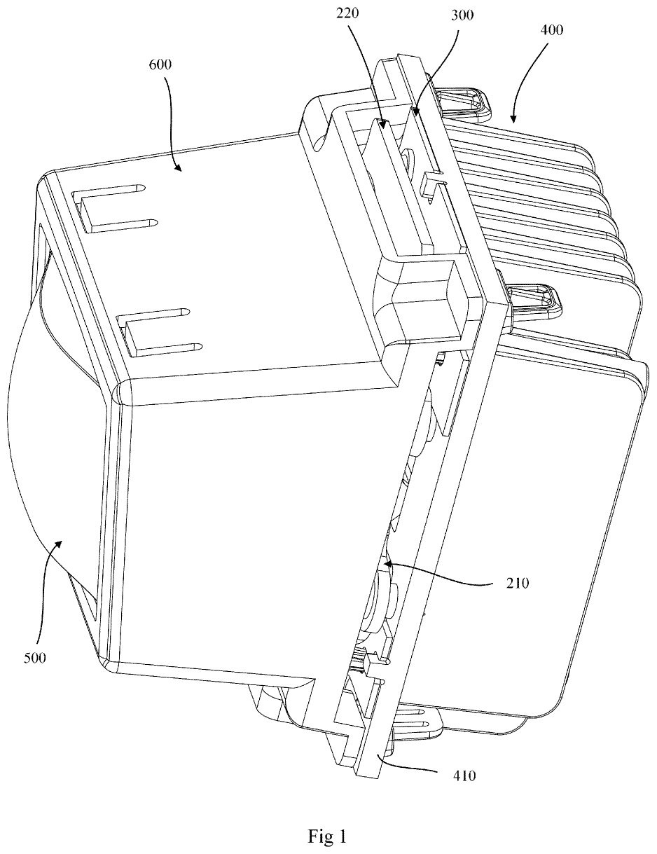

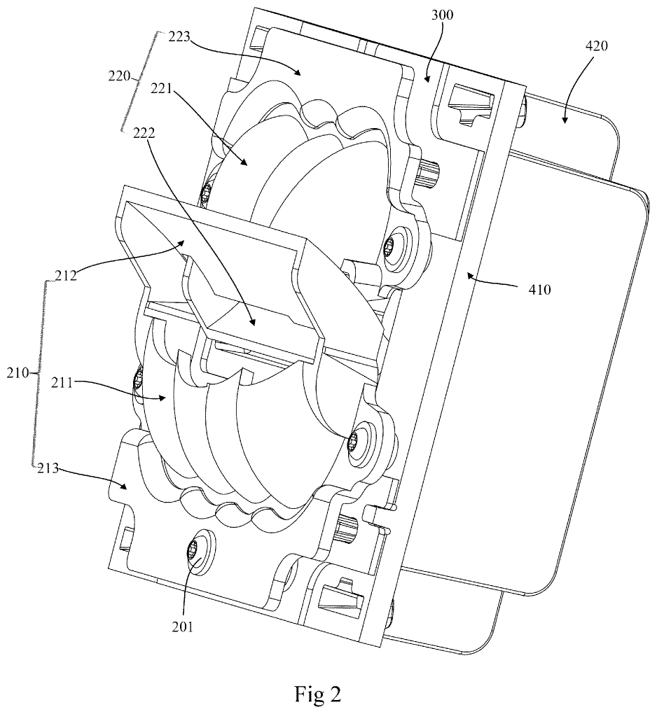

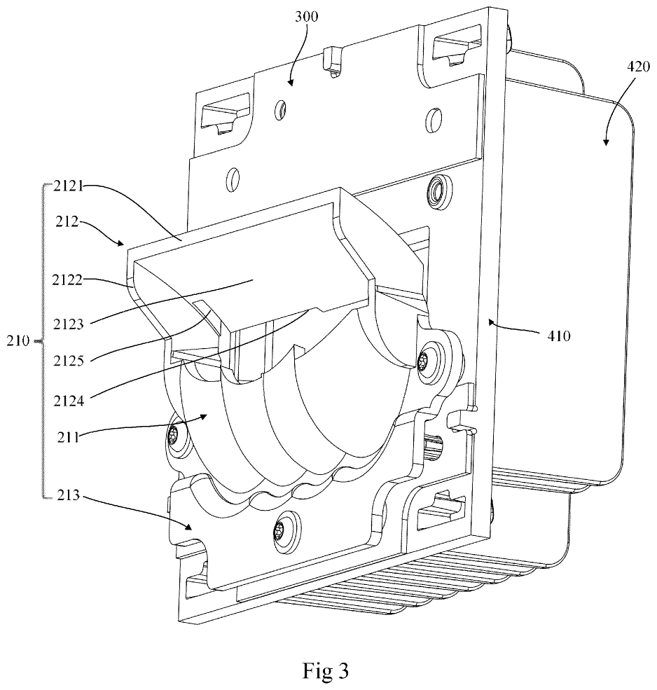

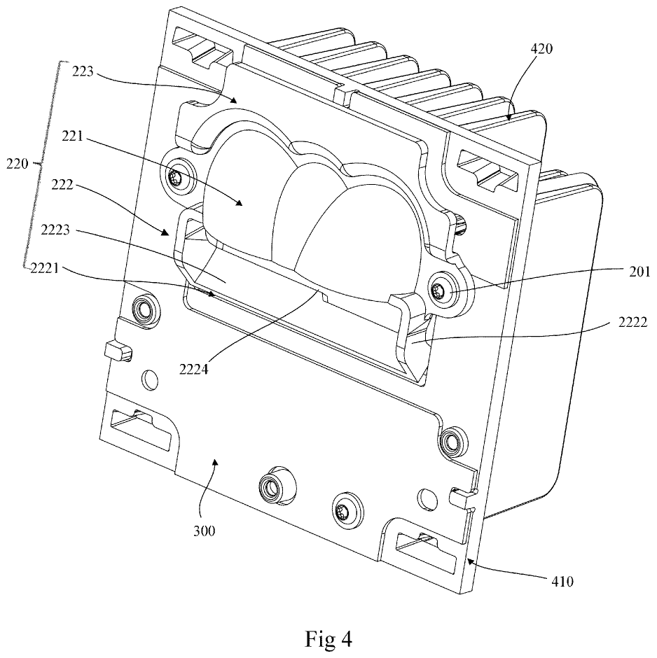

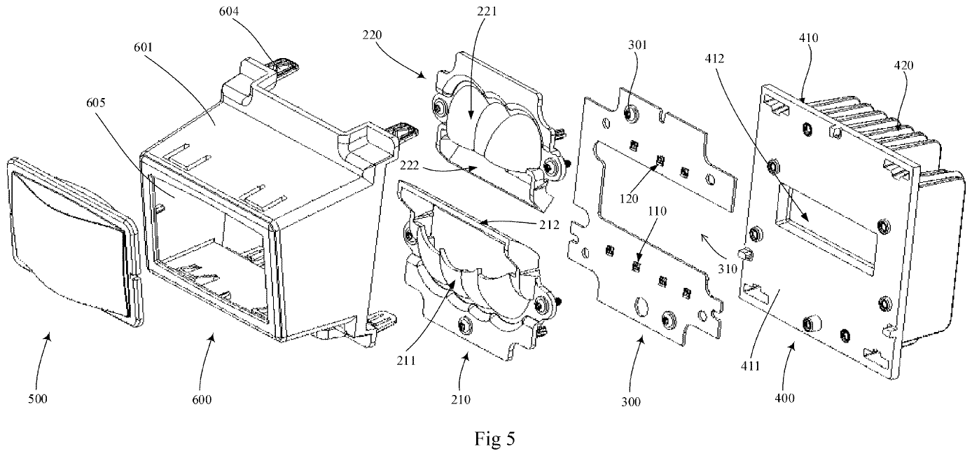

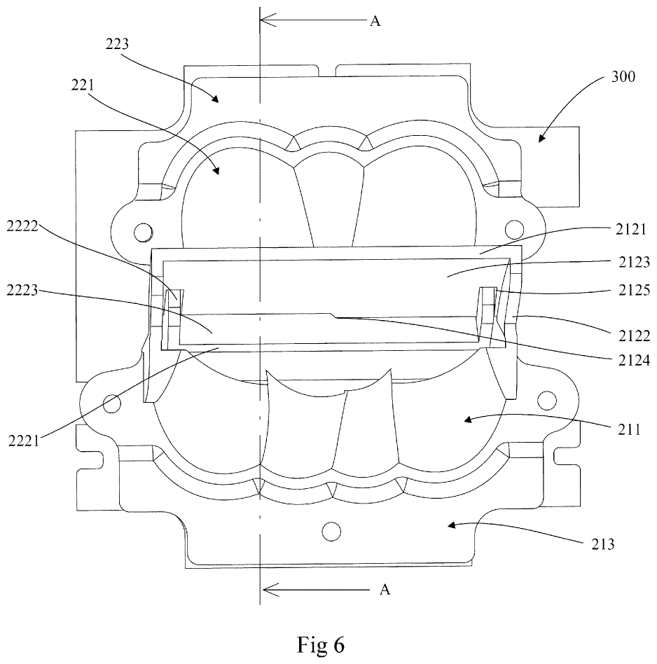

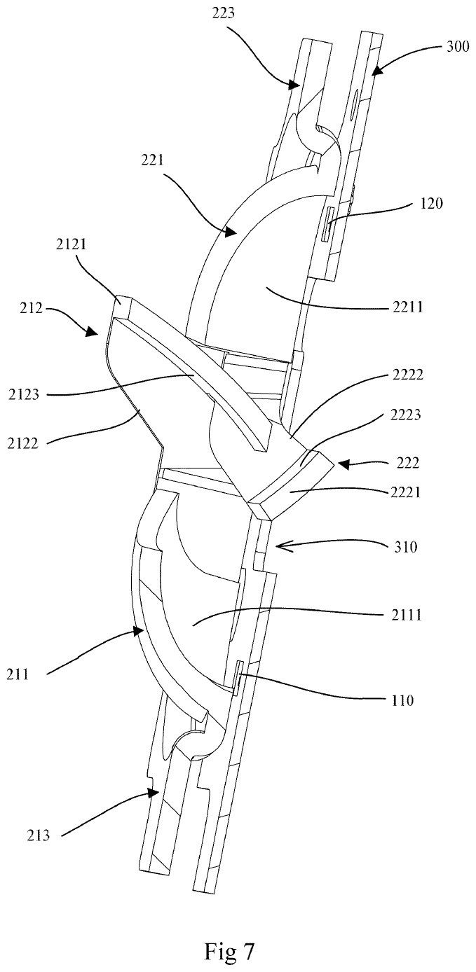

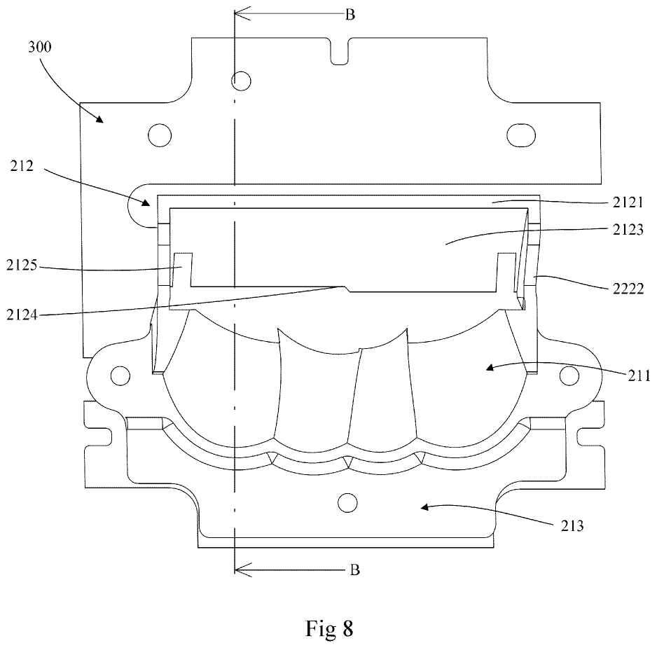

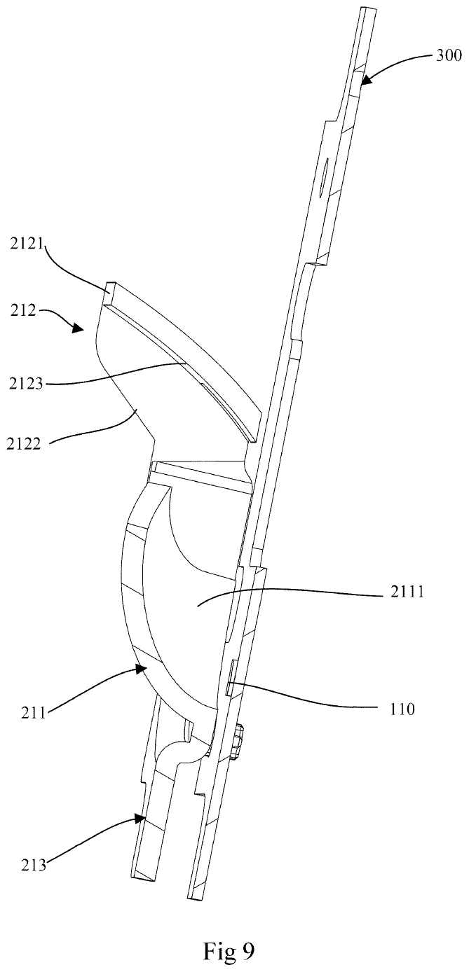

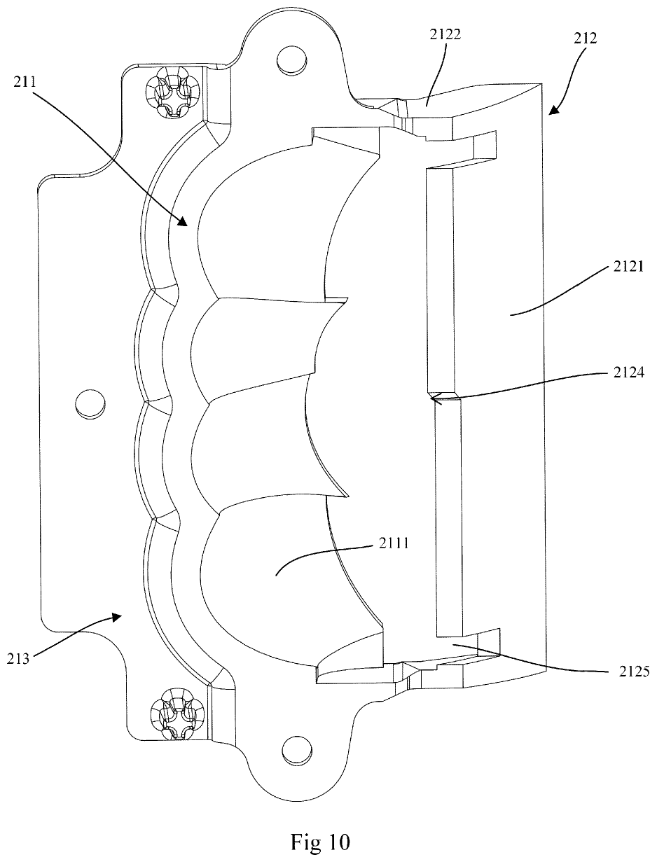

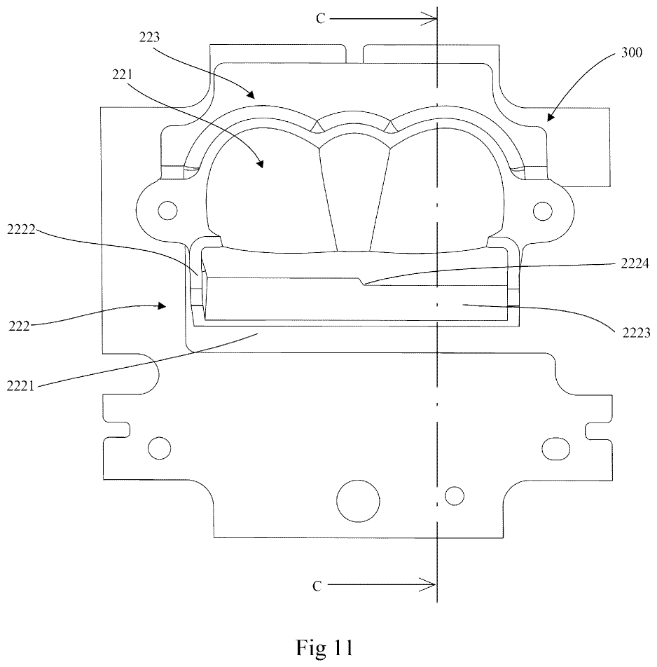

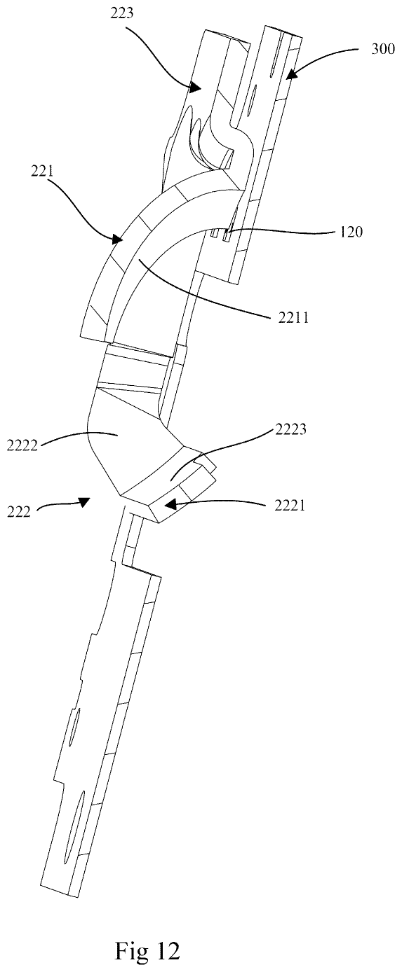

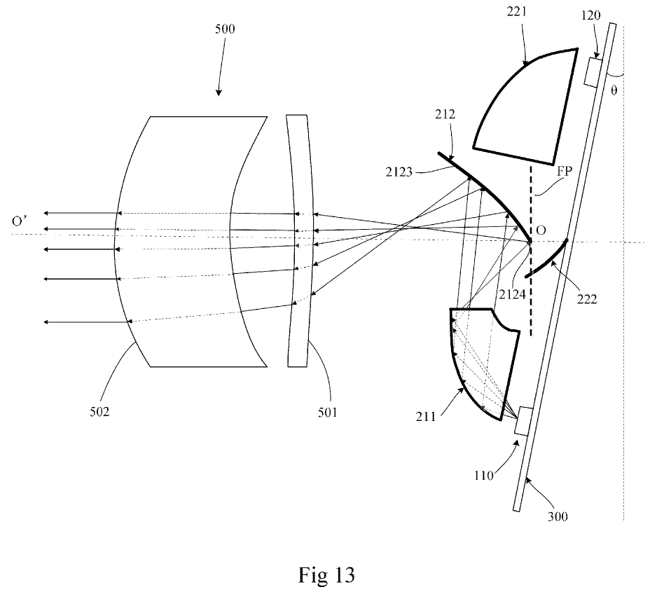

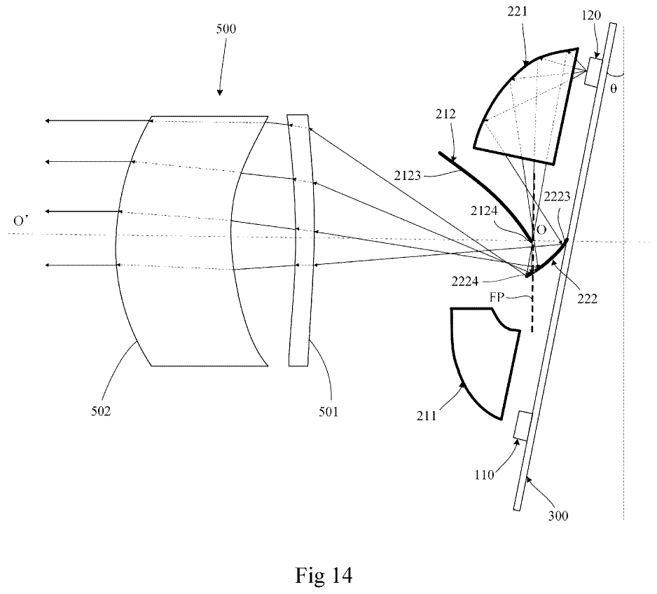

FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14 schematically show the structure of a lighting module according to an exemplary embodiment of the present disclosure, wherein the lighting module can function as a component of a lamp device, guiding light from a light source to be emitted with a desired illumination effect (for example, a desired intensity distribution or direction) to achieve lighting or signal indication functions. As an example, lamp devices may be mounted as lamps in vehicles, for example, including, but not limited to, headlights, such as dipped headlights and/or full beam headlights, or lamps that provide other lighting functions, such as interior lighting. It will be understood that in addition to the lighting module, the lamp device may further comprise other components not shown, such as a housing for accommodating the lighting module, an optional light distribution screen, connectors, and installation/positioning elements. The term “vehicle” mentioned herein can refer to any type of vehicle, such as a motor vehicle, a motorcycle, or any other mobile machine capable of carrying at least one passenger or used for transporting people or goods.

In the embodiment shown, the lighting module mainly comprises a light source (110; 120) and an integrated light shaping component (210; 220). The light source (110; 120) may comprise any suitable light-emitting device, for example, a halogen bulb, xenon lamp, LED, or laser, and, depending on actual needs, the lighting module may comprise one or more light sources (110; 120) arranged in various forms. A light source may be arranged on a carrier. As an example, the lighting module may further comprise a circuit board 300, for example, a PCB, with the light source (110; 120) mounted on the circuit board 300.

In order to dissipate the heat of the lighting module (for example, a light source or another heating component thereof) in a timely manner and effectively, the lighting module may further comprise a heat sink 400. As an example, the heat sink 400 may comprise a heat dissipation plate 410 for heat conduction and a plurality of heat dissipation fins 420 extending from the heat dissipation plate 410, and the light shaping component (210; 220) and the circuit board 300 carrying the light source (110; 120) may be mounted on the surface 411 of the heat dissipation plate 410, for example, being fixed to the heat dissipation plate 410 by fasteners 201 and 301, respectively, so that the light shaping component (210; 220) is at least partially or entirely located on one side of the circuit board 300 away from the heat sink 400.

In an embodiment of the present disclosure, the light shaping component (210; 220) can shape light from the light source (110; 120) into a beam with a desired lighting function (for example, a low beam or high beam function) for emission. The structure of a light shaping component will be further described below by referring to the attached drawings.

Optionally, in some embodiments, the lighting module may further comprise a light projection component for receiving a beam from the light shaping component (210; 220), and providing or projecting a lighting beam with a desired lighting effect (for example, an intensity distribution or emitting direction) towards, for example, the ground or area in front of the vehicle, such as a low beam and/or a high beam, which may be a parallel, or approximately parallel, beam. It will be understood that in the present disclosure, various forms of light projection components may be employed, including, but not limited to, various different arrangements of transmission components, reflectors, or light guides. In the embodiment shown, an example of using the lens 500 as a light projection component is described, wherein the lens 500 may be mounted on a lens bracket 600, and the lens bracket 600 may also be mounted on the same heat sink 400. In some examples, the optical axis of a light projection component (for example, the lens 500) may coincide with or be parallel to the optical axis O-O′ of the lighting module.

As an example, as shown in FIG. 1 and FIG. 5, the lens bracket 600 may have a frame-shaped structure, comprising a hollow housing 601, the housing 601 defining a window 605 for accommodating and mounting the lens 500, thereby allowing a beam shaped by the integrated light shaping component (210; 220) to propagate through the hollow housing 601 and exit through the lens 500. The housing 601 may be formed or provided with a mounting foot 604 for being fixed to the heat sink 400, for example, to cover the light shaping component, circuit board, and light source.

According to an embodiment of the present disclosure, the light shaping component (210; 220) comprises a light collection portion (211; 221) and a cut-off line forming portion (212; 222) that are integrated, the light collection portion (211; 221) being configured to collect light from the light source (110; 120) and guide the light towards the cut-off line forming portion (212; 222), and the cut-off line forming portion (212; 222) being configured to receive light from the light collection portion (211; 221) and shape the light into an outgoing beam with a cut-off line (for example, a horizontal cut-off line). Therefore, since the cut-off line forming portion and the light collection portion are formed into an integrated component, which means that the two portions are integrated (for example, being moulded) into an integrated light shaping component, material and manufacturing costs may be reduced, and there is no need to assemble a cut-off line forming portion, so that assembly requirements may be relaxed, space may be saved, and the relative position between the cut-off line forming portion and the light collection portion is fixed, without changing due to any vibrations or other factors, which ensures a stable light shaping effect.

It will be understood that the terms “integral” and “integrated” are used herein relative to “independent” or “separate”, meaning that an integral or integrated component exists as a single entity and excludes any parts that are independent of or separate from each other in space, wherein, for example, various parts of an integral or integrated component may be simultaneously or separately formed (for example, being moulded) and subsequently assembled together to form a single component.

In an exemplary embodiments, the light shaping component may shape and guide to emergent light from a light source in a reflective manner, so at least one of the light collection portion and cut-off line forming portion thereof may comprise a reflector or mirror, or have a reflective surface or reflective coating. Specifically, the light collection portion may reflect light from the light source towards the cut-off line forming portion, and the cut-off line forming portion may reflect the light from the light collection portion outwards in a desired or designed direction. For example, light shaping component may be made of materials with high heat resistance, for example, being moulded with glass or polymers, such as polycarbonate plastics (for example, PC-HT) or polyetherimide, and reflective surfaces may be formed by metallising or applying a coating on the surfaces of the formed light collection portion and cut-off line forming portion.

As an example, one or both of the light collection portion and the cut-off line forming portion may have one or more elliptical, parabolic, or semi-elliptical reflective surfaces. For example, the light collection portion may be a reflector at least partially facing the corresponding light source and cut-off line forming portion, with the light source being located at or near the focal point of the light collection portion, and the cut-off line forming portion being located at or near the focal point of the light collection portion. As an example, the reflective surface of the light collection portion may be a surface obtained by rotating around an axis parallel to the optical axis of the lighting module. As described below, the reflective surface of the cut-off line forming portion may be formed with a cut-off line forming structure, for example, a raised or stepped edge at a substantially horizontally extending edge, for example, wherein light coming from the light collection portion but falling beyond the cut-off line forming structure will be absorbed or blocked by other components of the lighting module, without being emitted, so that a light and dark cut-off line is formed in the outgoing beam, for example, a stepped horizontal cut-off line that is low on the left and high on the right when viewed in a forward direction, thereby meeting relevant regulations and driving safety requirements.

In the embodiments shown in FIGS. 1-2, 5-7, and 13-14, a single lighting module may be integrated with two different lighting functions or be able to provide two different lighting beams, wherein the light shaping component thereof comprises a first light shaping component 210 and a second light shaping component 220 to achieve two lighting functions, respectively, such as a low beam lighting function and a high beam lighting function. Correspondingly, a light source comprises one or more first light sources 110 for emitting light to the first light shaping component 210 and one or more second light sources 120 for emitting light to the second light shaping component 220, wherein the first light shaping component 210 is configured to shape light from the first light source 110 into a first beam with a first cut-off line, which is used for a first lighting function (as shown in FIG. 13), and the second light shaping component 220 is configured to shape light from the second light source 120 into a second beam with a second cut-off line, which is used for a second lighting function (as shown in FIG. 14).

As an example, the first lighting function may be a low beam function, while the second lighting function may be a high beam function, which means that the first light shaping component 210 is configured to provide a low beam either alone or together with a light projection component, and the second light shaping component 220 is configured to provide a high beam either alone or together with a light projection component. Depending on a specific application, the first and second light sources may be separately turned on to provide a low beam, a higher beam, or a mixed or complementary beam formed by a combination of a low beam and a high beam through a single lighting module at different times.

In an exemplary embodiment of the present disclosure, a lighting module integrated with two lighting functions may comprise only a single circuit board 300, with the first light source 110 and the second light source 120 being mounted on the same circuit board 300 at intervals, which allows a reduction of the number of connectors and wiring harnesses used to connect two or more circuit boards and a decrease in the volume of the lighting module. As shown in FIGS. 5-7, the circuit board 300 may have a U-shaped contour defining an opening 310, with the first light source 110 and the second light source 120 mounted on two sides of the opening having a U-shaped contour, respectively.

In addition, a lighting module integrated with two lighting functions may also comprise only a single heat sink 400, a circuit board 300 with a first light source 110 and a second light source 120 mounted, and a first light shaping component 210 and a second light shaping component 220 mounted on the same heat sink 400, thereby further reducing the volume of the lighting module. The second light shaping component 220 and the first light shaping component 210 may be located on the same side of the circuit board 300 away from the heat sink 400.

In some other embodiments, as shown in FIGS. 3-4 and 8-12, a single lighting module may comprise only a first light shaping component 210 for providing a low beam or only a second light shaping component 220 for providing a high beam.

In an embodiment of the present disclosure, the first light shaping component 210 and the second light shaping component 220 are respectively formed as a single or one-piece component integrated with a light collection portion and a cut-off line forming portion. In the case where a single lighting module is integrated with low beam and high beam lighting functions, the first and second light shaping components 210 and 220 may be arranged adjacent to each other, for example, adjacent to each other in the direction of intersection with (for example, being substantially perpendicular to or inclined relative to) the optical axis O-O′ of the lighting module (see FIGS. 13 and 14), substantially located on the opposite side of the optical axis O-O′.

In some applications, the lighting module may be slightly tilted inside the housing of the lamp device according to the arrangement of the light shaping component and the direction in which light emission is guided, wherein, for example, the surface 411 of the heat sink 400 for mounting a light shaping component or the circuit board 300 may be tilted at an angle θ relative to the vertical direction or the focal plane (FP) of a light projection component (for example, a lens), so that light from a light source, after being shaped and guided by the light shaping component, is projected from the light projection component to emit over an appropriate distance in front of the vehicle, rather than being projected downwards at an excessive tilt angle towards the road surface very close to the front of the vehicle, or projected upwards at an excessive tilt angle. The angle θ may be appropriately set according to actual applications, for example, within the range of 10° to 15°. In addition, such a tilt makes it convenient to mount a light shaping component, so that the light shaping component assumes a suitable shape, for example, an inclined surface shape that allows easy demoulding during manufacturing. In some examples, demoulding may be carried out from the cut-off line forming portion.

In the embodiment shown, the first light shaping component 210 comprises a first light collection portion 211 and a first cut-off line forming portion 212 that are integrated (for example, moulded or otherwise manufactured) together, with a gap or opening defined between the first light collection portion 211 and the first cut-off line forming portion 212 to allow light to be emitted. In addition, the first light shaping component 210 may also comprise a first mounting base 213, which extends from the first light collection portion 211 and may be mounted on the heat sink 400 by a fastener 201, in which case the first light collection portion 211 and the first cut-off line forming portion 212 may be spaced apart from the circuit board 300.

For example, the first light collection portion 211 may comprise a dome-shaped reflector, which is formed with a first reflective surface 2111 facing the inner wall of the first light source 110, for example, an elliptical, parabolic, or semi-elliptical surface. As an example, the first light collection portion 211 may be formed with a plurality of segments or reflective surfaces, such as concave surfaces, corresponding one-to-one to a plurality of first light sources 110.

As shown in the figure, the first cut-off line forming portion 212 may comprise a first main body 2121 and two first side connection portions 2122 located on two opposite sides of the first main body 2121, the first side connection portion 2122 extending from the first main body 2121 to the first light collection portion 211, so that the first light collection portion 211 and the first cut-off line forming portion 212 are joined or formed into one. The first main body 2121 may have a plate-like shape, spaced apart from the first light collection portion 211, to define a gap or opening between the first main body 2121 and the first light collection portion 211 that allows light to be emitted outwards, that is, allowing light to be reflected from the first light collection portion 211 with no or little obstruction onto the first main body 2121. The surface of the first main body 2121 facing the first light collection portion 211 may be an elliptical, parabolic, or semi-elliptical reflective surface 2123 to reflect light from the first light collection portion 211 outwards.

At the edge of the reflective surface 2123 of the first cut-off line forming portion 212, as shown in the figure, a first cut-off line forming structure 2124 may be formed, for example, a stepped edge with two horizontal flat parts, wherein light coming from the first light collection portion 211 but falling beyond the first cut-off line forming structure 2123 will be absorbed or blocked by other components of the lighting module or lamp device, without being emitted, so that a light and dark cut-off line is formed in the emitted beam, for example, a stepped horizontal cut-off line or upper cut-off line that is low on the left and high on the right when viewed in the forward direction, thereby meeting relevant regulations and driving safety requirements.

In some examples, the first cut-off line forming structure 2124 configured to form a cut-off line for a low beam may be located in or near the focal plane (FP) (as shown in FIGS. 13 and 14) of a light projection component (for example, the lens 500) to form a clear cut-off line in the low beam, while the remaining portion of the reflective surface 2123 of the first cut-off line forming portion 212 may be located upstream of the focal plane (FP) (that is, upstream of light propagation along the optical axis O-O′).

Similarly, the second light shaping component 220 comprises a second light collection portion 221 and a second cut-off line forming portion 222 that are integrated (for example, moulded or otherwise manufactured) together, with a gap or opening defined between the second light collection portion 221 and the second cut-off line forming portion 222 to allow light to emit. In addition, the second light shaping component 220 may further comprise a second mounting base 223, which extends from the second light collection portion 221 and may be mounted on the heat sink 400 by a fastener 201, in which case the second light collection portion 221 and the second cut-off line forming portion 222 may be spaced apart from the circuit board 300.

For example, the second light collection portion 221 may comprise a dome-shaped reflector, which is formed with a second reflective surface 2211 facing the inner wall of the second light source 120, for example, an elliptical, parabolic, or semi-elliptical surface. As an example, the second light collection portion 221 may be formed with a plurality of reflective surfaces, such as concave surfaces, corresponding one-to-one to a plurality of second light sources 120.

The second cut-off line forming portion 222 may comprise a second main body 2221 and two second side connection portions 2222 located on two opposite sides of the second main body 2221, the second side connection portion 2222 extending from the second main body 2221 to the second light collection portion 221, so that the second light collection portion 221 and the second cut-off line forming portion 222 are joined or formed into one. The second main body 2221 may have a plate-like shape, for example, and may be spaced apart from the second light collection portion 221 to define a gap or opening between the second main body 2221 and the second light collection portion 221 that allows light to be emitted outwards, that is, allowing light to be reflected from the second light collection portion 221 with no or little obstruction onto the second main body 2221. The surface of the second main body 2221 facing the second light collection portion 221 may be an elliptical, parabolic, or semi-elliptical reflective surface 2223 to reflect light from the second light collection portion 221 outwards.

In some examples, at the edge of the reflective surface 2223 of the second cut-off line forming portion 222, as shown in the figure, a second cut-off line forming structure 2224 may also be formed, for example, a stepped edge with two horizontal flat parts, wherein light coming from the second light collection portion 221 but falling beyond the second cut-off line forming structure 2223 will be absorbed or blocked by other components of the lighting module or lamp device, without being emitted, so that a light and dark cut-off line is formed in the emitted beam, for example, a stepped horizontal cut-off line that is low on the left and high on the right when viewed in the forward direction, thereby meeting relevant regulations and driving safety requirements.

In some examples, the second cut-off line forming structure 2224 configured to form a cut-off line for a high beam may be located near the focal plane (FP) (as shown in FIGS. 13 and 14) of a light projection component (for example, the lens 500), for example, downstream near the focal plane (FP) or slightly off the focal plane (FP) in the direction of the optical axis, or located in the focal plane (FP), thereby forming a substantially clear cut-off line in the high beam, while the remaining majority of the reflective surface 2223 of the second cut-off line forming portion 222 may be located upstream of the focal plane (FP).

In some embodiments, as shown in FIGS. 2, 6, 7, 13, and 14, the second light collection portion 221 is arranged on the upper side of the first light collection portion 211, while the second cut-off line forming portion 222 is mostly or entirely arranged on the lower side of the first cut-off line forming portion 212, in which case the second cut-off line forming portion 222 may be partially embedded in the first cut-off line forming portion 212, so that the second cut-off line forming portion 222 is at least partially exposed from the gap or opening defined between the first light collection portion 211 and the first cut-off line forming portion 212, thereby allowing light from the second light source 120 to be emitted from the gap or opening between the first light collection portion 211 and the first cut-off line forming portion 212 after being shaped and guided by the second light collection portion 221 and the second cut-off line forming portion 222.

As an example, in the first main body 2121 of the first cut-off forming portion 212, as in a lower part of the first main body 2121, a groove 2125 may be formed, the second side connection portion 2222 of the second cut-off forming portion 222 is at least partially embedded in the groove 2125, but the reflective surface 2223 of the second main body 2221 of the second cut-off forming portion 222 is spaced apart from the first main body 2121 (for example, its lower edge) of the first cut-off forming portion 222, which allows light to be emitted at an appropriate angle on after being reflected by the reflective surface 2223.

As shown in FIGS. 2, 4, and 5, a groove 412 may be formed in the surface 411 of the circuit board 300 facing the heat dissipation plate 410, and the second cut-off line forming portion 222 is at least partially positioned inside the groove 412, thereby providing a more compact structure.

Although the present disclosure has been described in conjunction with the accompanying drawings, the embodiments disclosed in the drawings are intended to illustrate preferred embodiments of the present disclosure and should not be construed as limiting the present disclosure. The dimensional proportions in the drawings are merely schematic, and must not be interpreted as a limitation of the present disclosure.

Although some embodiments of the general concept of the present disclosure have been shown and described, those ordinarily skilled in the art will understand that changes can be made to these embodiments without departing from the principle and spirit of the general concept of the present disclosure. The scope of the present disclosure is defined by the claims and their equivalents.

What is claimed is:

1. A lighting module comprising:
a light source; and
a light shaping component configured to shape light from the light source into a beam with a desired lighting function for emission,
the light shaping component includes a light collection portion and a cut-off line forming portion that are integrated, the light collection portion being configured to collect light from the light source and guide the light towards the cut-off line forming portion, and the cut-off line forming portion being configured to receive light from the light collection portion and form the light into an outgoing beam with a cut-off line.

2. The lighting module according to claim 1, wherein at least one of the light collection portion and the cut-off line forming portion includes a reflector.

3. The lighting module according to claim 2, wherein the light collection portion is configured to reflect light from the light source towards the cut-off line forming portion, and the cut-off line forming portion is configured to reflect outwards light reflected from the light collection portion.

4. The lighting module according to claim 3, wherein the light collection portion is a reflector with a focal point at or near the light source.

5. The lighting module according claim 1, wherein the cut-off line forming portion includes a main body spaced apart from the light collection portion and two side connection portions located on two opposite sides of the main body, wherein
the side connection portion extends from the main body to the light collection portion, so that the light collection portion and the cut-off line forming portion are integrated into one part, and
an opening that allows light to pass through is defined between the main body and the light collection portion.

6. The lighting module according to claim 5, wherein at least one of the main body of the cut-off line forming portion and the light collection portion has one or more elliptical, parabolic or semi-elliptical reflective surfaces.

7. The lighting module according to claim 6, wherein the cut-off line forming portion has a reflective surface with a cut-off line forming structure.

8. The lighting module according to claim 1, wherein the light shaping component includes at least one of a first light shaping component and a second light shaping component, the first light shaping component being configured to provide a first beam with a first lighting function and a first cut-off line, and the second light shaping component being configured to provide a second beam with a second lighting function and a second cut-off line.

9. The lighting module according to claim 8, wherein the first lighting function is a low beam function, and the second lighting function is a high beam function.

10. The lighting module according to claim 9, wherein the lighting module includes a first light shaping component and a second light shaping component arranged adjacent to each other, the first light shaping component and the second light shaping component being each formed as a single component, and
the light source includes one or more first light sources for emitting light to the first light shaping component and one or more second light sources for emitting light to the second light shaping component.

11. The lighting module according to claim 10, wherein the cut-off line forming portion of the second light shaping component is partially embedded in the cut-off line forming portion of the first light shaping component, so that the cut-off line forming portion of the second light shaping component is at least partially exposed from a gap defined between the light collection portion and the cut-off line forming portion of the second light shaping component.

12. The lighting module according to claim 10, further comprising a single circuit board, wherein the first light source and the second light source are mounted at intervals on the circuit board.

13. The lighting module according to claim 12, further comprising a single heat sink, wherein the circuit board, first light shaping component, and second light shaping component are mounted on the heat sink, so that the second light shaping component and the first light shaping component are located on the same side of the circuit board away from the heat sink.

14. The lighting module according to claim 13, wherein the circuit board has a U-shaped contour defining an opening, and the first and second light sources are respectively mounted on two sides of the opening having a U-shaped contour.

15. The lighting module according to claim 13, wherein the heat sink includes a heat dissipation plate and a plurality of heat dissipation fins extending from the heat dissipation plate, wherein a groove is formed on a surface of the circuit board facing the heat dissipation plate, and the cut-off line forming portion of the second light shaping component is at least partially positioned inside the groove.

16. The lighting module according to claim 14, further comprising a lens, wherein the lens is configured to project a beam from a light shaping component outwards to become a lighting beam.

17. The lighting module according to claim 16, wherein the cut-off line forming portion is formed with a cut-off line forming structure located in or near a focal plane of the lens at the edge.

18. A lamp device comprising a lighting module, with the lighting module including a light source, and a light shaping component configured to shape light from the light source into a beam with a desired lighting function for emission, the light shaping component includes a light collection portion and a cut-off line forming portion that are integrated, the light collection portion being configured to collect light from the light source and guide the light towards the cut-off line forming portion, and the cut-off line forming portion being configured to receive light from the light collection portion and form the light into an outgoing beam with a cut-off line.

19. A vehicle comprising a lamp device that includes a lighting module, with the lighting module including a light source, and a light shaping component configured to shape light from the light source into a beam with a desired lighting function for emission, the light shaping component includes a light collection portion and a cut-off line forming portion that are integrated, the light collection portion being configured to collect light from the light source and guide the light towards the cut-off line forming portion, and the cut-off line forming portion being configured to receive light from the light collection portion and form the light into an outgoing beam with a cut-off line.
